(19) United States
(12) Patent Application Publication
(10) Pub. No.: US 2007/0046254 A1
(43) Pub. Date: Mar. 1, 2007

(54) Power supply device of an electronic product

(75) Inventors: Jeff Chen, Taipei (TW); Lee-Te Chen, Taipei (TW)

Correspondence Address: BRUCE H. TROXELL;SUITE 1404, 5205 LEESBURG PIKE, FALLS CHURCH, VA, 22041, US

(73) Assignee: Advanced Connectek Inc.

(21) Appl. No.: 11/211,529

(22) Filed: Aug. 26, 2005

(51) Int. Cl. H02J 7/00

(52) U.S. Cl. 320/107

(57) ABSTRACT

The present invention relates to a power supply device of a portable electronic product, especially, to a charging device having a built-in power storage unit. By means of the built-in power storage unit in the charging device, the power storage unit would enter a discharge mode to provide power to the portable electronic product or to charge its battery when the external power is not available, and this function of the present invention is not limited to time, locations or the power source and so on various external conditions.

### BACKGROUND OF THE INVENTION

1. Field of the Invention

The present invention relates to a power supply device of an electronic product, especially, to a charging device having a built-in power storage unit.

2. Description of Related Art

The conventional portable electronic products are generally using rechargeable miniature batteries (secondary batteries), such as NiH battery, NiCd battery or Li-Ion battery and so on. The charging operation of these miniature batteries have two modes—desktop charge and travel charge, the charging power source is from the main supply. Thereinto, when in travel charge mode, the main supply is converted to direct current (DC), the battery is charged with high electrical current directly, in this condition, the battery is disposed within the portable electronic product. This mode has an advantage of fast charge and no need to shut down the electronic product, but the defect is the battery is hard to be fully charged for its charging feature; as in the desktop charge mode, it uses a charging stand having a charging circuit, the portable electronic product or the battery could be received in the insertion slots of the charging stand for performing a charging operation. In such a charge mode, the battery is first charged under a fixed current and then charged under a fixed voltage when the battery is charged to a certain extent of voltage, this mode of charging is usually called as deep charge, which costs more time but the battery is fully charged relatively.

Recently, the USB and the FIREWIRE (IEEE1394) transmission interfaces of the computer could provide DC power, therefore there is also a charging stand for which the DC power is provided by the computer through a USB or FIREWIRE transmission cord. Such kind of charging stand omits a device for converting AC (alternating current) to DC (replaced by the power supplier of the computer), but the charging mode thereof is approximately identical to that of the above-said charging stand using the main supply as its power source, they all charge under a fixed current first and then charge under a fixed voltage.

From the above seen, in order to get the battery of the portable electronic product been charged fully, it would be more appropriate to use a charging stand for charging, but it needs the supply of the main supply no matter to directly use the main supply as power source or to use the DC power provided by the computer through a USB or FIREWIRE transmission cord as power source, because the operation of the computer also needs the main supply, and it must be in electrical connecting state during the whole charging process, that is to say the charging stand must be placed beside the main supply socket or adjacent to the computer and could not be used separately.

But sometimes the user could not wait for a long time for the completion of such a charging process for some reasons, in this condition, the advantage of the charging stand could not be brought into full play, for example, the user maybe has only one or two hours for charging, but the battery has not been fully charged yet. And sometimes when the user is in the outside or the main supply is not available, the charging stand is only to be a receiving stand, it could not perform the function of charge and hasn't the ability of supplying power.

### SUMMARY OF THE INVENTION

It is a main object of the present invention to provide a charging device of a portable electronic product, which, by use of a built-in power storage unit, could provide power for the operation of the portable electronic product through the power stored in the power storage unit when the external power is not available.

It is another object of the present invention to provide a charging device of a portable electronic product, which, by use of a built-in power storage unit, could get the battery been charged to a sufficient state when the external power is not available and make the charging operation is not limited to time, locations and power source.

To achieve the above objects, the charging device of the portable electronic product according to the present invention comprises a receiving body and a power transmission member. The receiving body comprises at least one receiving slot, a power storage unit, a circuit board and a power input port, the at least one receiving slot having a plurality of connecting ports each connected with the circuit board, the circuit board having a related charging circuit, the power storage unit being connected with the circuit board, the power input port being connected with the circuit board; the power transmission member could be connected to the power input port at one end and to the external power at the other end.

When the power transmission member is connected to the power input port at one end and to the external power at the other end, the external power provides power for the circuit board through the power transmission member. At this moment, the portable electronic product or the battery could be inserted into the connecting ports of the receiving slots, the circuit board could supply power to the portable electronic product or charge the battery through the charging circuit, besides, the charging circuit also could charge the power storage unit, the charging technology in this portion is not described any more as it is similar to that of the known technology.

The features of the present invention wherein the power storage unit would enter a discharge mode to supply power to the portable electronic product or to charge the battery through the charging circuit if the portable electronic product or the battery is inserted into the connecting port of the receiving slot when the power transmission member is not connected with the power input port and the external power.

The charging device except for the basic function of charging or supplying power, the above said connecting ports disposed inside the receiving slots have various interfaces of different functions, for example, interface integrated the power source with the analog audio signal or interface integrated the power source with the digital signal, the present invention could integrate with other peripheral functions by use of such different interfaces further to be a multi-function charging device.

### BRIEF DESCRIPTION OF THE DRAWINGS

FIG. 1 is a perspective view of a first embodiment of the present invention;

FIG. 2 is a perspective view of the first embodiment of the present invention when used;

FIG. 3 is a logic flow chart of the first embodiment of the present invention;

FIG. 4 is a perspective view of a second embodiment of the present invention;

FIG. 5 is a perspective view of a third embodiment of the present invention; and

FIG. 6 is a perspective view of a fourth embodiment of the present invention.

### DETAILED DESCRIPTION OF THE PREFERRED EMBODIMENTS

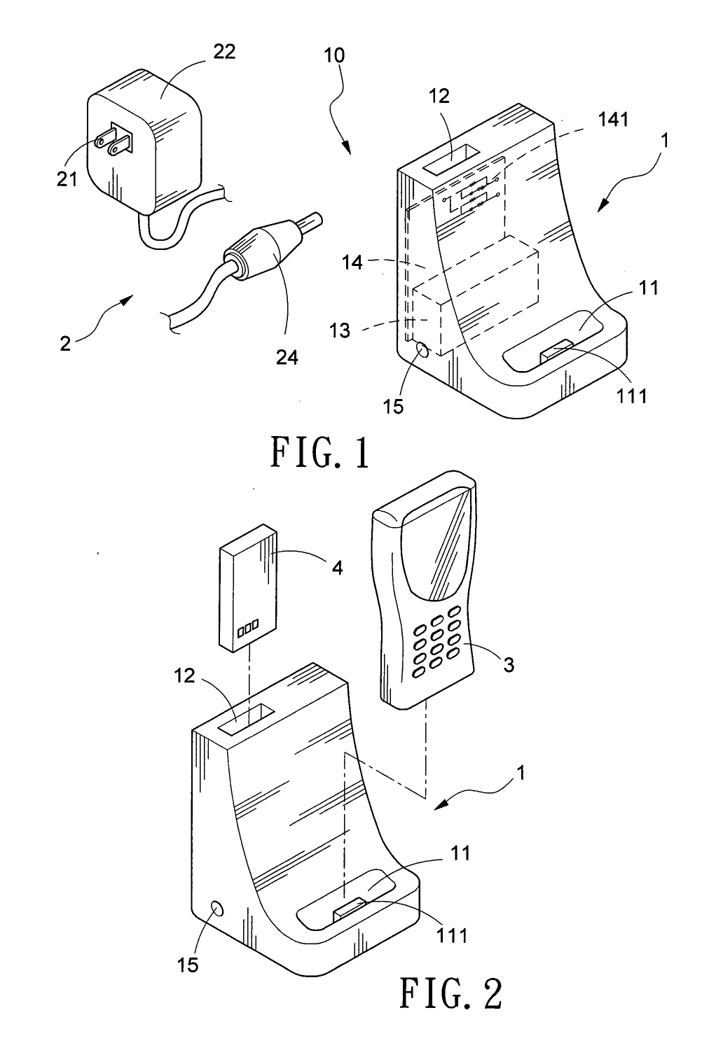

Referring to FIGS. 1 and 2, the charging device of a first embodiment of the present invention is a charging stand for a mobile phone, the mobile phone is supplied with power by a battery, the charging stand has a charging circuit therein for providing DC to the mobile phone and could charge the battery. The charging device 10 of the present embodiment comprises a receiving body 1 and a power transmission member 2, the receiving body 1 comprises a first receiving slot 11, a second receiving slot 12, a power storage unit 13, a circuit board 14 and a power insertion hole 15. The circuit board 14 has a related charging circuit 141, the first receiving slot 11 has a first connecting port 111 therein connected with the circuit board 14, the second receiving slot 12 has a second connecting port (not shown) therein connected with the circuit board 14, the power storage unit 13 is connected with the charging circuit 141, the power insertion hole 15 acts as a power input port and connects with the circuit board 14, one end of the power transmission member 2 could be inserted into the power insertion hole 15, and the other end is a power plug 21 for connecting with the external power-the main supply.

The power transmission member 2 has an electrical current converting circuit 22, when one end of the power transmission member 2 is connected with the power insertion hole 15 and the other end—the power plug 21 is inserted into the main supply socket (not shown), the AC from the main supply is converted into a DC of fixed current and fixed voltage and be supplied to the circuit board 14 through the power insertion hole 15. At this moment, if the mobile phone 3 is inserted into the first connecting port 111 in the first receiving slot 11, the circuit board 14 would supply power to the mobile phone 3 through the first connecting port 111; if the battery 4 is inserted into the second connecting port in the second receiving slot 12, the charging circuit 141 would charge the battery 4; besides, the charging circuit 141 would also charge the power storage unit 13.

When the external power is not available (i.e. the power transmission member 2 is not connected with the power insertion hole 15 and the main supply socket), if the mobile phone 3 is inserted into the first connecting port 111 in the first receiving slot 11 or the battery 4 is inserted into the second connecting port in the second receiving slot 12, the power storage unit 13 would enter a discharge mode to provide power to the mobile phone 3 or to charge the battery 4 through the charging circuit 141.

The above power storage unit could be a rechargeable secondary battery, such as, Lead-Acid electrochemical battery, NiH battery, NiCd battery or Li-Ion battery etc. The above battery used in the mobile phone is usually a battery having the function of storing power, such as, Lead-Acid electrochemical battery, NiH battery, NiCd battery or Li-Ion battery etc.

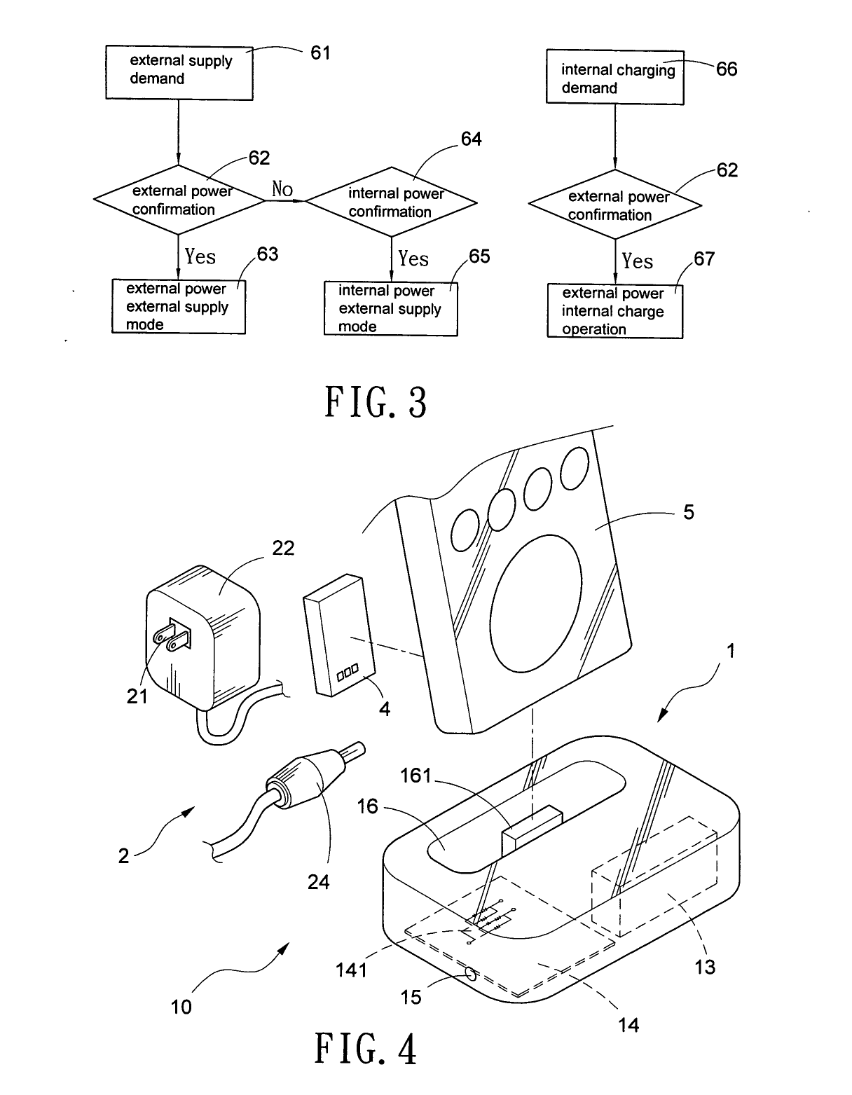

Referring to FIG. 3, which is a logic flow diagram of the first embodiment of the present invention. If the mobile phone 3 is inserted into the first connecting port 111, an external supply demand 61 would be started, at this moment, the charging device 10 would proceed an external power confirmation 62 to detect whether there is any electrical current supplied from the power insertion hole 15, if yes, the charging device 10 would supply power to the mobile phone 3 through the external power in external power external supply mode 63, if there is no external power, the charging device 10 would supply power to the mobile phone 3 through the built-in power storage unit 13 in internal power external supply mode 65 after verified by the internal power confirmation 64.

Besides, when the power stored in the power storage unit 13 is under a set extent, the internal charging demand 66 is started, at this time the charging device 10 would carry out an external power confirmation 62, if there is electrical current supplied from the power insertion hole 15, then the charging device 10 would charge the power storage unit 13 by means of external power internal charge operation 67. In addition, if the battery 4 is inserted into the second receiving slot 12, the external supply demand 61 would be started as above said, now the charging device 10 would proceed an external power confirmation 62 to detect whether there is any electrical current supplied from the power insertion hole 15, if yes the charging device 10 would charge the battery 4 through the external power via the charging circuit 141 of the circuit board 14 in external power external supply mode 63, if there is no external power, the charging device 10 would charge the battery 4 with power provided by the built-in power storage unit 13 through the charging circuit 141 of the circuit board 14 in internal power external supply mode 65 after verified by the internal power confirmation 64.

Referring to FIG.4, a second embodiment of the present invention is a charging device for a portable digital music player, the portable digital music player uses a battery to provide power and has a charging circuit therein, it would charge the battery directly by providing an external DC power. The charging device 10 comprises a receiving body 1 and a power transmission member 2, the receiving body 1 comprises a receiving slot 16, a power storage unit 13, a circuit board 14 and a power insertion hole 15. The circuit board 14 has a related charging circuit 141, the receiving slot 16 has a connecting port 161 therein connected with the circuit board 14, the power storage unit 13 is connected with the circuit board 14, the power insertion hole 15 acts as a power input port and connects with the circuit board 14, one end of the power transmission member 2 could be inserted into the power insertion hole 15, the other end is a power plug 21 for connecting with the external power-the main supply.

The power transmission member 2 has an electrical current converting circuit 22, when one end of the power transmission member 2 is connected with the power insertion hole 15 and the other end—the power plug 21 is inserted into the main supply socket, the AC from the main supply is converted into a DC of fixed current and fixed voltage and be supplied to the circuit board 14 through the power insertion hole 15. At this moment, if the digital music player 5 were inserted into the connecting port 161 in the receiving slot 16, the circuit board 14 would supply power to the digital music player 5 and charge the battery 4 in digital music player 5; besides, the charging circuit 141 would also charge the power storage unit 13 simultaneously.

When the external power is not available (i.e. the power transmission member 2 is not connected with the power insertion hole 15 or the main supply socket), if the digital music player 5 is inserted into the connecting port 161 in the receiving slot 16, the power storage unit 13 would enter a discharge mode to provide power to the digital music player 5.

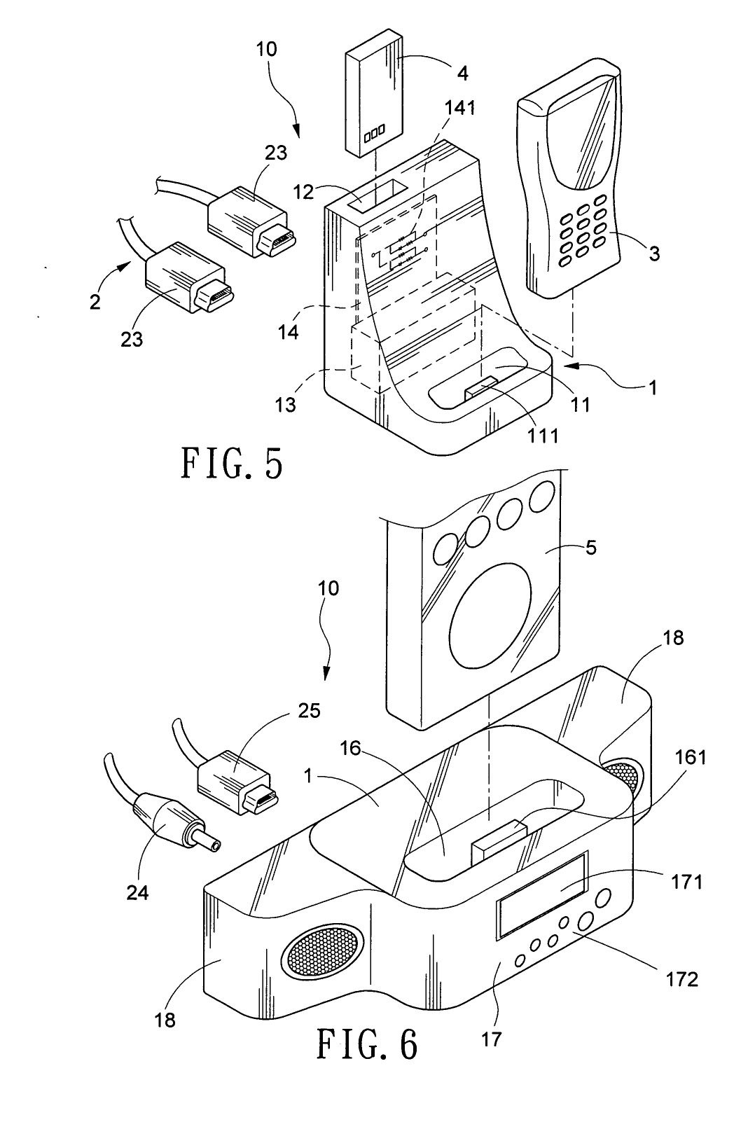

Referring to FIG. 5, which is a third embodiment of the charging device according to the present invention. The charging device of this embodiment is same as the first embodiment whose charging device is for the mobile phones, and all of the components of this embodiment is similar to those of the first embodiment approximately, the difference lies in that as viewing from the FIG. 5, the power transmission member 2 of this embodiment is a USB transmission cord having USB connectors 23-23 on both end thereof, the power input port of the charging device 10 is a USB connector which could mate with the USB connector 23 on one end of the power transmission member 2, the other end of the power transmission member 2 is also a USB connector 23 connected with the USB output port of the computer, to use the power provided by the computer as the external power.

Similarly, when the charging device 10 is provided with external power by a computer, if the mobile phone 3 is inserted into the first connecting port 111 in the first receiving slot 11, the circuit board 14 would supply power to the mobile phone 3 through the first connecting port 111; if the battery 4 is inserted into the second connecting port in the second receiving slot 12, the charging circuit 141 would charge the battery 4; besides, the charging circuit 141 would also charge the power storage unit 13. When the external power is not available, if the mobile phone 3 is inserted into the first connecting port 111 in the first receiving slot 11 or the battery 4 is inserted into the second connecting port in the second receiving slot 12, the power storage unit 13 would enter a discharge mode to provide power to the mobile phone 3 or to charge the battery 4 through the charging circuit 141.

The USB transmission cord of the third embodiment also could be changed into a FIREWIRE transmission cord.

Referring to FIG. 6, which is a fourth embodiment of the charging device according to the present invention. The charging device of this embodiment is similar to the second embodiment which is also a charging stand for the portable digital music player, the difference lies in that the charging device 10 of the third embodiment further comprises an operation interface 17 composed of an operation screen 171 and a plurality of operation buttons 172 and two electrical signal output ports (not shown). It could control the digital music player 5 through the operation interface 17, the two electrical signal output ports are connected respectively with two speakers 18 through which the digital music stored in the digital music player 5 could be played out for listening. Besides, the power input port of the charging device 10 has two types of modes, one is a DC plug and the other one is a USB connector, which could be selected for using as an external power input port.

The charging device 10 has a power storage unit 13(not shown), therefore, the charging device 10 could supply power through the built-in power storage unit 13 to the digital music player 5 for charging or playing music when the external power is not available.

The spirit of the invention consists in the built-in power storage unit of the charging device, making the charging device could supply power through the built-in power storage unit to the portable electronic product for operation or to the battery for charging operation when the external power is not available. The structures of the embodiments disclosed in the present invention are illustrative only and not limitative to the scope of the present invention. In the present invention, it could has other embodiments, for example, the power storage unit 13 and the receiving body 1 could be disposed separately and then be combined for use when they are to be used for convenient to manufacture or transportation. Therefore any changes or modifications made by those skilled in the art via the description of the present invention without departing from the spirit of the invention are considered as like structures and covered by the claims of the present invention.

What is claimed is:

1. A charging device of a portable electronic product, comprising:
a receiving body comprising:
a circuit board having a related charging circuit;
a power storage unit connected with said circuit board;
at least one receiving slot, for receiving said portable electronic product or a battery thereof, having a plurality of connecting ports each connected with said circuit board; and
a power input port connected with said circuit board; and
a power transmission member for being connected to said power input port at one end and connected to an external power at the other end;
wherein said power storage unit would enter a discharge mode to provide power to said portable electronic product or to charge the battery thereof when the external power is not available.

2. The charging device of the portable electronic product, as claimed in claim 1, wherein one end of said power transmission member is a DC plug and the other end is a power plug, and the external power is AC source.

3. The charging device of the portable electronic product, as claimed in claim 1, wherein the two ends of the power transmission member are USB plugs, and the external power is DC source.

4. The charging device of the portable electronic product, as claimed in claim 1, wherein the two ends of the power transmission member are FIREWIRE plugs, and the external power is DC source.

5. The charging device of the portable electronic product, as claimed in claim 1, wherein said power storage unit is a rechargeable secondary battery.

6. The charging device of the portable electronic product, as claimed in claim 1, wherein said receiving body further comprises an operation interface through which could operate or control said portable electronic product.

7. The charging device of the portable electronic product, as claimed in claim 6, wherein said operation interface includes an operation screen and a plurality of operation buttons.

8. The charging device of the portable electronic product, as claimed in claim 1, wherein said receiving body further includes an electrical signal output port and at least one output periphery device.

9. The charging device of the portable electronic product, as claimed in claim 1, wherein said battery is a rechargeable secondary battery.

10. A charging device of a portable electronic product having a receiving body, comprising:
a circuit board having a related charging circuit;
a power storage unit connected with said circuit board;
at least one receiving slot, for receiving said portable electronic product or a battery thereof, having connecting ports each connected with said circuit board; and
a power input port, for inputting an external power, connected with said circuit board;
wherein said power storage unit enters a discharge mode to provide power to said portable electronic product or to charge the battery thereof when the external power is not available.

11. The charging device of the portable electronic product, as claimed in claim 10, wherein said power storage unit is a rechargeable secondary battery.

12. The charging device of the portable electronic product, as claimed in claim 10, wherein said receiving body further comprises an operation interface through which could operate or control said portable electronic product.

13. The charging device of the portable electronic product, as claimed in claim 12, wherein said operation interface includes an operation screen and a plurality of operation buttons.

14. The charging device of the portable electronic product, as claimed in claim 10, wherein said receiving body further includes an electrical signal output port and at least one output periphery device.

15. The charging device of the portable electronic product, as claimed in claim 10, wherein said battery is a rechargeable secondary battery.

16. A charging device of a portable electronic product having a receiving body, comprising:
a circuit board having a related charging circuit;
a power storage unit connected with said circuit board;
at least one receiving slot, for receiving said portable electronic product or a battery, having a plurality of connecting ports each connected with said circuit board;
a power input port, for inputting the external power, connected with said circuit board; and
at least one electrical signal output port for transmitting the electrical signal out of said portable electronic product,
wherein said power storage unit would enter a discharge mode to provide power to said portable electronic product or to charge the battery thereof when the external power is not available.

17. The charging device of the portable electronic product, as claimed in claim 16, wherein said power storage unit is a rechargeable secondary battery.

18. The charging device of the portable electronic product, as claimed in claim 16, wherein said receiving body further comprises an operation interface through which could operate or control said portable electronic product.

19. The charging device of the portable electronic product, as claimed in claim 18, wherein said operation interface includes an operation screen and a plurality of operation buttons.

20. The charging device of the portable electronic product, as claimed in claim 16, wherein said receiving body further includes at least one output periphery device which is connected with the electrical signal output port for receiving electrical signal.

21. The charging device of the portable electronic product, as claimed in claim 10, wherein the power storage unit and the receiving body is disposed separately and then combined for use when they are to be used.

22. The charging device of the portable electronic product as claimed in claim 16, wherein the power storage unit and the receiving body is disposed separately and then combined for use when they are to be used.
